(19) United States
(12) Patent Application Publication
(10) Pub. No.: US 2012/0078684 A1
(43) Pub. Date: Mar. 29, 2012

(54) APPARATUS AND METHOD FOR REPRESENTING A LEVEL OF INTEREST IN AN AVAILABLE ITEM

(76) Inventors: Giuliano MACIOCCI, Duxford (GB); Paul MABBUTT, Werrington (GB)

(21) Appl. No.: 13/216,044

(22) Filed: Aug. 23, 2011

Related U.S. Application Data
(60) Provisional application No. 61/387,455, filed on Sep. 28, 2010.

(51) Int. Cl. G06Q 30/02

(52) U.S. Cl. 705/7.29

(57) ABSTRACT

A method and apparatus for representing a level of interest in at least one available item includes determining a release date for one or more applications and calculating a level of interest for each of the one or more applications. Calculating the level of interest includes searching media for discussion of each of the one or more applications. The method and apparatus further include generating a user interface configured to represent the level of interest in the one or more applications based on the determined release date, and providing the user interface to a mobile device. Additionally, in optional aspects, a personalized level of interest may be calculated based on access to user information for one or more available items.

### CLAIM OF PRIORITY UNDER 35 U.S.C. §119

The present Application for Patent claims priority to Provisional Application No. 61/387,455 entitled “APPARATUS AND METHOD FOR THE DISPLAY OF A LEVEL OF INTEREST IN AVAILABLE APPLICATIONS” filed Sep. 28, 2010, assigned to the assignee hereof and hereby expressly incorporated by reference herein.

### BACKGROUND

The present disclosure relates generally to communication systems, and more particularly to a method, system, apparatus, computer program product, and processor for representing a level of interest for a plurality of available items, such as applications within an application store.

Wireless communication systems are widely deployed to provide various telecommunication services such as telephony, video, data, messaging, and broadcasts. Communication may be established between a network and user equipment (UE) such as a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem.

Application stores are services for UE that allow users to browse and download applications from the application stores to the UE. Depending on the application, they may be available either free or at a cost. The applications can be downloaded directly to a UE from a user interface at the application store. Application stores may be accessible directly from the UE.

In the past, rankings have been provided for various applications based on the number of applications purchased or downloaded. However, this ranking provides only limited information regarding interest in an application.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects include a method for representing a level of interest in at least one available item. The method includes determining a release date for one or more applications and calculating a level of interest for each of the one or more applications. In this aspect, calculating the level of interest includes searching media for discussion of each of the one or more applications. The method further includes generating a user interface configured to illustrate the level of interest in the one or more applications based on the determined release date, and providing the user interface to a mobile device.

Aspects may further include at least one processor configured to represent a level of interest in at least one available item. The at least one processor includes a first module for determining a release date for one or more applications, and a second module for calculating a level of interest for each of the one or more applications. In this aspect, calculating the level of interest includes searching media for discussion of each of the one or more applications. The at least one processor further includes a third module for generating a user interface configured to illustrate the level of interest in the one or more applications based on the determined release date, and a fourth module for providing the user interface to a mobile device.

Aspects may further include a computer program product to represent a level of interest in at least one available item, including a non-transitory computer-readable medium. The computer-readable medium includes at least one instruction for causing a computer to determine a release date for one or more application, and at least one instruction for causing the computer to calculate a level of interest for each of the one or more applications. In such aspect, calculating the level of interest includes searching media for discussion of each of the one or more applications. The computer-readable medium further includes at least one instruction for causing the computer to generate a user interface configured to illustrate the level of interest in each of the one or more applications based on the determined release date, and at least one instruction for causing the computer to provide the user interface to a mobile device.

Aspects may further include an apparatus to represent a level of interest in at least one available item comprising means for determining a release date for one or more applications, and means for calculating a level of interest for each of the one or more applications. In this aspect, calculating the level of interest includes searching media for discussion of each of the one or more applications. The apparatus further includes means for generating a user interface configured to illustrate the level of interest in each of the one or more applications based on the determined release date, and means for providing the user interface to a mobile device.

Aspects may further include an apparatus to represent a level of interest in at least one available item including an application interest level generation component configured to determine a release date for one or more applications, and calculate a level of interest for each of the one or more applications. In this aspect, calculating the level of interest includes searching media for discussion of each of the one or more applications, and generating a user interface configured to illustrate the level of interest in each of the one or more applications based on the determined release date, and a transmitter configured to provide the user interface to a mobile device.

Aspects may further include a method for obtaining a level of interest in at least one available item. The method includes receiving a user interface configured to represent the level of interest in one or more applications based on a release date. In such aspect, the level of interest for each of the one or more applications is calculated based on a media search for discussion of each of the one or more applications, and presenting the received user interface on a display.

Aspects may further include at least one processor configured to obtain a level of interest in at least one available item. The at least one processor includes a first module for receiving a user interface configured to represent the level of interest one or more applications based on a release date. In such aspect, the level of interest for each of the one or more applications is calculated based on a media search for discussion of each of the one or more applications, and a second module for presenting the received user interface on a display.

Aspects may further include a computer program product to obtain a level of interest in at least one available item, including a non-transitory computer-readable medium. The computer-readable medium includes at least one instruction for causing a computer to receive a user interface configured to represent the level of interest in one or more applications based on a release date. In such aspect, the level of interest for each of the one or more applications is calculated based on a media search for discussion of each of the one or more applications, and at least one instruction for causing the computer to present the received user interface on a display.

Aspects may further include an apparatus to obtain a level of interest in at least one available item including means for receiving a user interface configured to represent the level of interest in one or more applications based on a release date. In this aspect, the level of interest for each of the one or more applications is calculated based on a media search for discussion of each of the one or more applications, and means for presenting the received user interface on a display.

Aspects may further include an apparatus to obtain a level of interest in at least one available item, including a communications component configured to receive a user interface configured to represent the level of interest in one or more application based on a release date. In such aspect, the level of interest for each of the one or more applications is calculated based on a media search for discussion of each of the one or more applications, and a display configured to present the received user interface.

To the accomplishment of the foregoing and related ends, the one or more aspects comprise the features hereinafter described in detail and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of an example user interface for viewing the level of interest in one or more available items, according to one aspect.

FIG. 2 is an illustration of an example user interface for viewing the level of interest in one or more available items, according to one aspect.

FIGS. 3A-3C are illustrations of example user interfaces for viewing the level of interest in one or more available items, according to one aspect.

FIG. 4 is an illustration of an example user interface for viewing the level of interest in one or more available items, according to one aspect.

FIG. 5 is a flow chart of a method of representing a level of interest for at least one available item, according to one aspect.

FIG. 6 is a flow chart of a method of obtaining a level of interest to a user for one or more available items, according to one aspect.

FIG. 7 is a diagram of an example computer device, according to one aspect.

FIG. 8 is a diagram of an example computer device, according to one aspect.

FIG. 9 is a conceptual block diagram illustrating the functionality of an example apparatus, according to one aspect.

FIG. 10 is a conceptual block diagram illustrating the functionality of an example apparatus, according to one aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Aspects enable the determination, representation and presentation or display of a level of interest and/or popularity of at least one available item. As used in this disclosure, an “available item” may include one or more of a content item, content, a service item, a service, or an electronic representation of at least one of a content item, content, a service item, or a service. As used in this disclosure, the term “content” or “content item” includes, at least, one or more of any type of application, multimedia file, image file, executable, program, web page, script, document, presentation, message, a website, music, a movie, data, meta-data, or any other type of media or information that may be rendered, processed, or executed on a device, or an electronic identification of any of the foregoing. Also, as used in this disclosure, the term “service item” or “service” includes, at least, receiving or providing of an action or an accommodation, or obtaining a right thereto, including in electronic or non-electronic form. For example, in one aspect, a service may include providing access, such as access to a network server, access to a physical location such as a building, a restricted area, etc. For instance, in one aspect that should not be construed as limiting, a use case of providing access to a network server may include a scenario where a user is a player in a game, and access is provided to a network server to enable the user to participate in a network-based multi-player service for the game provided by the network server. Additionally, for instance, in an aspect that should not be construed as limiting, a use case of providing access to a physical location may include providing access and/or a membership to a gym. In an example, which should not be construed as limiting, one or more available items in some of the aspects described herein may include at least one application. In another aspect, such as a personalized representation of a level of interest, which should not be construed as limiting, one or more available items may include any number and/or any combination of a content item and/or a service item.

In an aspect, the presentation or display may be provided, for example, within an application store environment. For example, in an aspect, the application store environment may be presented on a computer device. Further, in other aspects, the application store environment may be a mobile store application environment presented on a mobile device. In one or more aspects, rather than creating a static list of available items ranked by a number of downloads or selections, an interest level in the available items may be determined by searching media for discussion of different available items in order to calculate a level of interest in the available items. This calculation may be made in combination with information regarding downloads and selections of the available items. The calculation may also be personalized to a specific user.

For example, in one aspect, media may be searched for at least one application in order to calculate a level of interest for each of the at least one application. In one aspect, this calculation may occur at a network device associated with a mobile device or user equipment (UE). Then, the network device can generate a user interface configured to represent the level of interest in the at least one application and provide the user interface to the mobile device or UE. The mobile device or UE may further provide access to personal information that enables the network to personalize the calculation of level of interest or popularity of one or more available items.

The presentation of the user interface at the mobile device or UE, e.g. on a display, is configured to enable a user to obtain an overall sense of the number of available items as well as the relevance of the various available items for a particular time frame. For example, the user interface may display a stacked or collapsed identifier or icon for a plurality of available items having the same release date. In an aspect, the user may navigate the display by moving forward and backward in time. In another aspect, the user may also use multi-touch interaction in order to zoom in to view stacked or collapsed available items. For example, zooming may include expanding the display on a vertical scale while maintaining the horizontal scale of the display in order to enlarge the stacked or collapsed available items. For example, in an aspect, this feature enables the stacked available items to be unstacked and displayed at a relatively larger or full size.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

In the subject disclosure, the word “example” is used herein to mean serving as an example, instance, or illustration. Any aspect or design described herein as “example” is not necessarily to be construed as preferred or advantageous over other aspects or designs. Rather, use of the word example is intended to present concepts in a concrete fashion.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

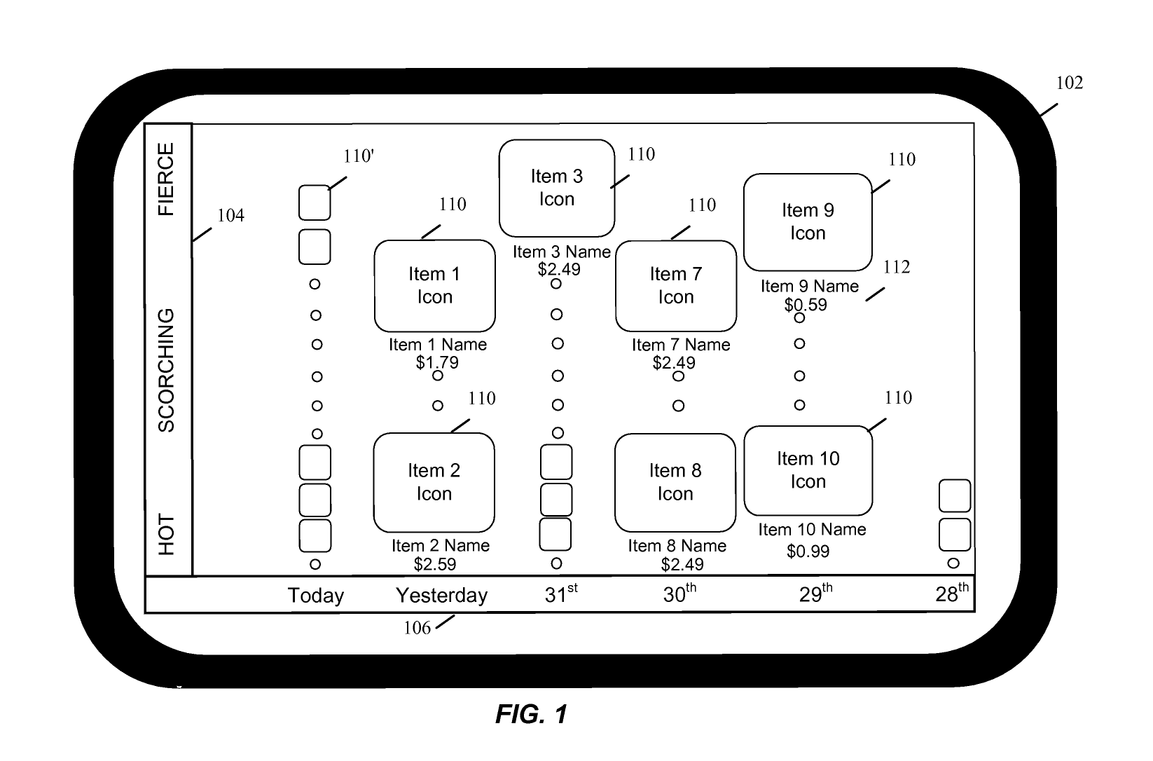

FIG. 1 illustrates aspects of an exemplary screen shot of an example of a user interface 102 displayed on a computer device, such as a mobile device. The user interface 102 illustrated in FIG. 1 provides a user with a way to easily discover one or more available items, such as a content item or a service item that may be obtained by a mobile device, and currently generating the most interest. According to one aspect, interest may be based on more than purchases of such available item. For example, interest may be gauged by news coverage, social media recommendations, the relative number of times that each available item is identified in electronic media such as blogs, websites, searches at search engines, and at social media sites, etc. in addition to the amount of views/accesses/downloads/purchases for each of the available items. Electronic searches can be performed to determine the number of times that each available item is mentioned in such media. Search results may also be weighted according to the source for the search result. For example, a news story mentioning an available item, such as an application, on a major news website may be weighted higher than a social media site comment regarding the application. The available item can then be ranked accordingly. Furthermore, a ranking of interest in various available items may be personalized to each user by providing access to user information such as log in credentials to social media accounts, contact list information, location information, etc. Such access may be provided via the user's mobile device.

FIG. 1 illustrates that, in one aspect, the rankings may be displayed on a 2D grid user interface 102 showing a level of interest 104 (e.g., hot, scorching, fierce, etc.) versus a timeline 106, such as a release date. In FIG. 1, the available items that are considered to have relatively higher levels of interest appear higher on the user interface 102. At the bottom of the user interface 102, in one aspect, is timeline 106 so that various available items may be ranked according to different dates. The timeline may represent, for example, a release date. Thus, the display may allow a user to visually determine which available items are trending by the item's release date. The timeline may also show popularity or interest in one or more available items based on date. Thus, the user can determine which of one or more available items have generated the most interest, such as discussion and purchases, each day.

In one aspect, one or more available items are represented by an icon 110, 110′, and may further include supplemental item information 112, such as the application name, source, price, etc. For example, if the available items are applications offered for sale, the applications may be represented by an application icon along with identifying information such as the application name, source, price, etc.

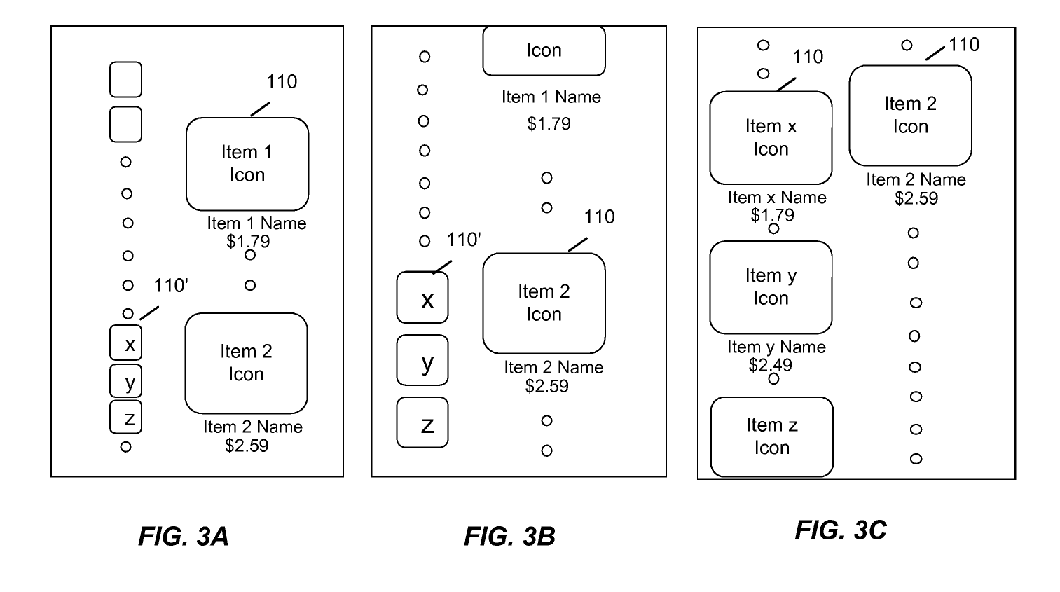

Referring to FIGS. 3A-3C, in an aspect, the user interface 102 includes a zooming mechanism so that multiple available items having a similar level of interest, for example in a single time period such as on a single day or release date, can be identified. For example, if there are multiple available items on a particular day that share a similar level of interest, and there is not enough screen space to show them, the icons 110 for the available items may be displayed as minimized icons 110′. The zooming mechanism may then be used in order to increase the vertical scale of the display so that the previously minimized icons are expanded. For example, the zooming mechanism may be a pinch-type mechanism that uses a gesture applied to a touch-sensitive display, such as touching two fingers to the screen and moving them in opposite directions in order to expand the display. Other zooming mechanisms may also be used.

FIGS. 3A-C illustrate a portion of a display screen at a user interface having minimized icons that become expanded to show the full icon and information for multiple items of content, according to one aspect. In FIG. 3A, the icons for x, y, and z are minimized This may also be referred to herein as “stacked” or “collapsed.” In FIG. 3B, the icons for x, y, and z have been slightly expanded based on user input. In FIG. 3C, the icons for x, y, and z have been fully expanded to illustrate the full icon, the application name, and price. As illustrated in FIGS. 3A-C, in one aspect, the zooming mechanism may change only the vertical scale of the display without altering the horizontal scale. This enables identifying information for overlapping items to be stacked or collapsed within a similar area, such as a column representing a given release date. Then, if the user is interested, the icons for each of the items can be unstacked by the user through application of the zooming mechanism to increase the vertical scale of the display.

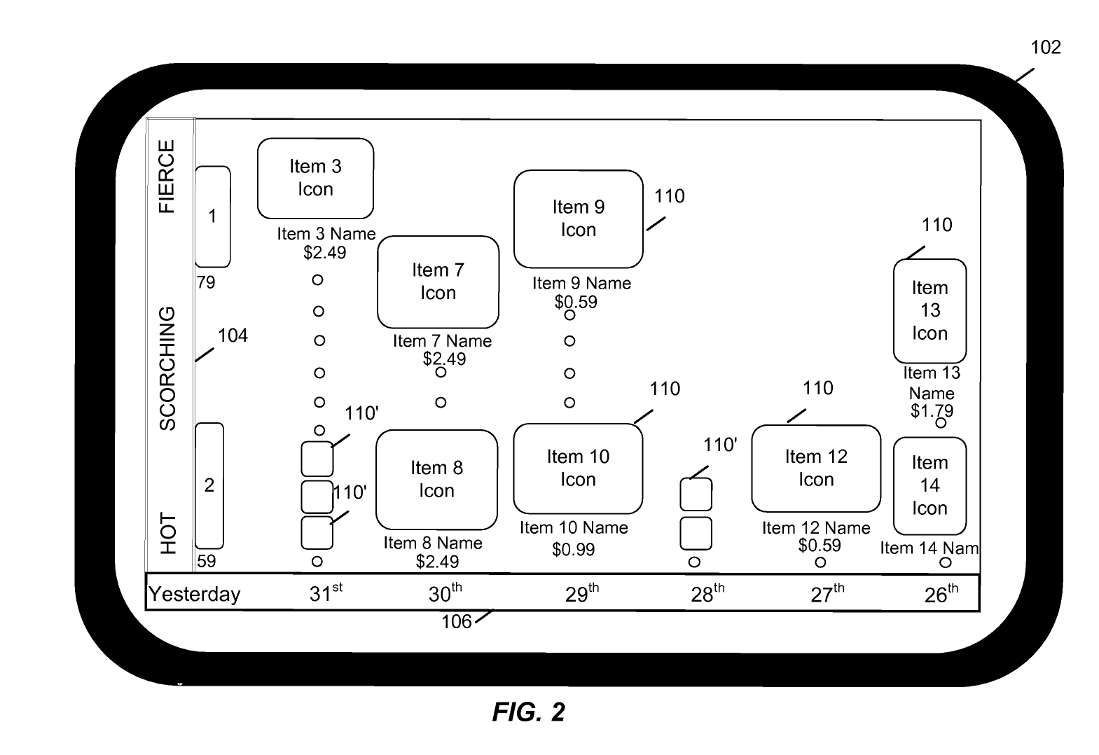

Additionally, in some aspects, the display may pan in any direction in order to view different dates, and in order to view content having higher and lower levels of interest. For example, FIG. 2 illustrates a similar view to FIG. 1, as a user browses past dates. The display may also be expanded and contracted as desired by the user, such as via the zooming mechanism.

Once a user desires more information regarding a particular available item, the user can select the icon, such as by tapping the screen, in order view a detailed description of the application.

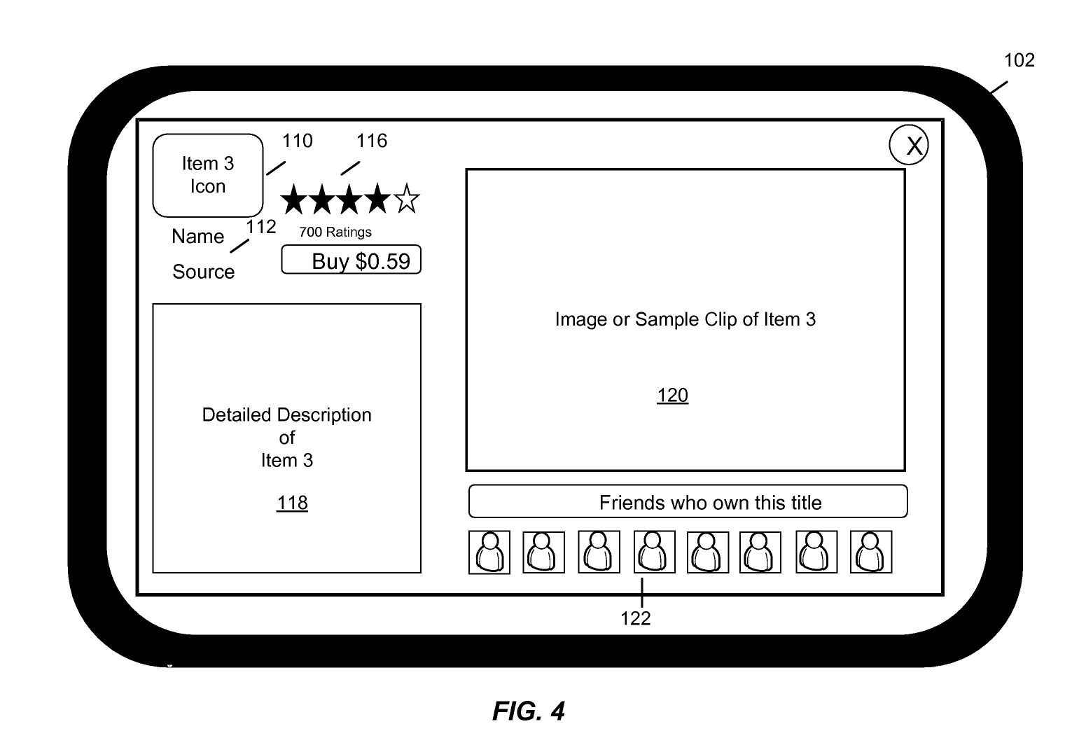

For example, FIG. 4 illustrates an example display via the user interface 102 for a particular available item. For instance, in one aspect, the available item icon 110 may be illustrated, as well supplemental information 112, such as the available item name, price, and the source of acquiring the available item. An average user rating 116 may be shown, as well as an identification of the number of reviews that have been received for the available item. A detailed description 118 of the available item may be provided. A sample image or animated clip 120 of the available item may be provided. In addition, the detailed description 118 for each available item may be personalized to each user. For example, the detailed description 118 may inform the user of friends or contacts 122 of the user that own or have downloaded the available item. The friends and contacts 122 of the user may be identified via the social network information of the user or via contact information on the device of the user, such as a UE, which may be made available to an available item interest level generation component at a network device, or alternatively locally on the device, which calculates the level of interest.

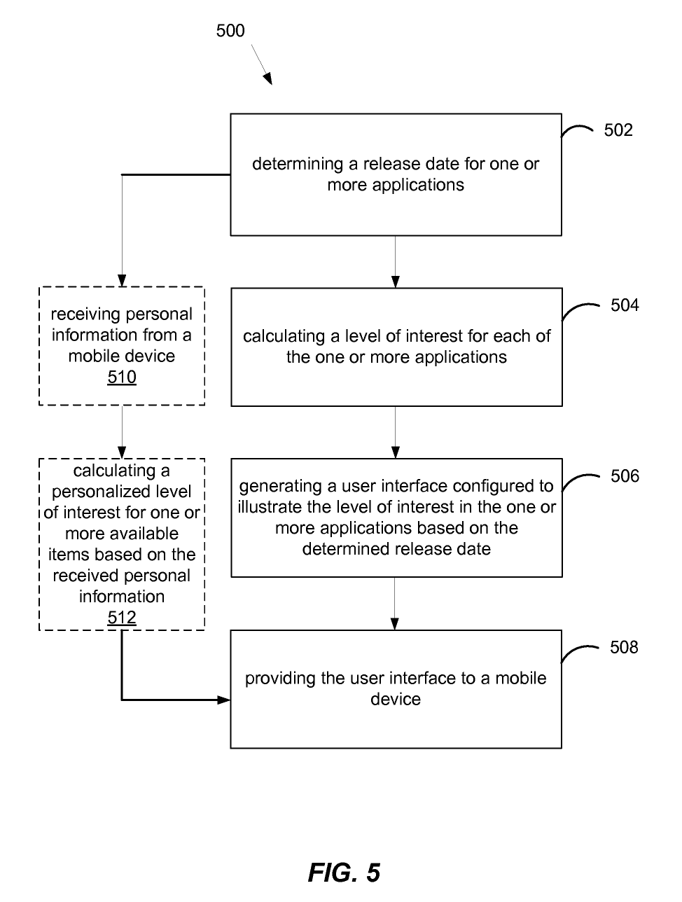

FIG. 5 illustrates a flow chart showing example aspects of a method 500 for representing a level of interest in one or more available items. For example, in an aspect, method 500 may be operable at a network device. The method includes determining a release date for one or more applications 502. An application store will have access to release date information. Often, this information will be stored as meta data regarding the one or more applications. For example, when an application is updated, the release date for that application would then reflect the latest version of the application. Further, in an aspect, news stories, blog entries, and other social media commentary, relating to the latest version of an application may be weighted higher than for previous versions of the application. For example, if an application has had several updates since its initial launch, ranking information regarding the latest update may be multiplied by 1, whereas similar information for the previous version may be multiplied by a lower weight such as 0.75. Information regarding an earlier version may be weighted by a corresponding lower weight, such as 0.5. Additional earlier versions may be weighted with an increasingly lower weight or may be weighted by a minimum weight, such as 0.25 or even zero if there is a long time period between versions or if one version is considered to be significantly different from another version. The ranking information that is weighted may include the social media commentary that is found for the applications.

The method further includes calculating a level of interest for each of the one or more applications, wherein calculating the level of interest includes searching media for discussion of each of the one or more applications 504.

The method further includes generating a user interface configured to represent the level of interest in the one or more applications based on the determined release date 506.

The method further includes providing the user interface to a mobile device 508.

The method may optionally include additionally receiving personal information from a mobile device 510 and calculating a personalized level of interest for one or more available items based on the received personal information 512, such as personalized level of interest for the one or more applications (e.g. the one or more applications of 502, 504, and 506), as well as for other types of available items, such as one or more of any content item or any service item.

The media may include social media, blogs, in addition to more traditional media, such as news articles/commentary. Searching the media for discussion of each of the plurality of applications may include electronic searches to determine a number of times that each of the one or more applications is named in various media. This information may be combined with the number of downloads and/or purchases in order to calculate the level of interest for each of the one or more applications.

Aspects may further include receiving personal information from the mobile device, as discussed infra, and calculating a personalized level of interest for one or more available items based on the received personal information. As noted above, the personalized level of interest may be for any available items, including the one or more applications as well as other types of available items.

The personal information from the mobile device may include receiving at least one of log in credentials for a social network, contact list information, or location information. When log in credentials for a social network of a user of the mobile device are received, aspects may further include searching the user's social network to determine a level of interest in the one or more available items based on the social network of the user, such as among the user's social contacts. When contact list information identifying a plurality of contacts is received, aspects may further include searching for purchases of any of the one or more available items by any of the plurality of contacts and searching for comments regarding any of the one or more available items by any of the plurality of contacts.

For example, the calculation may include data mining of the social media accounts of the user of the device to determine the amount of discussion regarding each of the plurality of applications specific to the friends and contacts of the user. The contact list information may be used to weight the number of downloads/comments made by persons included in the contact list of the user.

For example, calculating a level of interest for the one or more available items may include determining a number of overall downloads, A, for each of the one or more available items, determining a number of downloads made by contacts of the user, B, and calculating a level of interest by calculating A−B+x(B), wherein x is a numerical multiplier to weight the level of interest of contacts of the user. This may enable a single download or comment by a contact of the user to increase the calculated level of interest comparable to an available item that has been downloaded by a large number of other persons. The calculation may further take into account the average rating given to an available item both by friends of the user and by the overall public who has downloaded the available item. This information may be used in combination with the download information in order to provide a multiplying factor in the equation A-B+x(B). For example, if a rating system ranked available items on a scale from 1-5, with the average rating of an available item for a user's friends, C, and the overall average rating of the available item, D, then a ranking could also be calculated as (A/D)−(B/C)+x(B/C). In this equation, x represents a weighting multiplier based on the ranking system being used.

The method may further include configuring the user interface to display an icon for each of the one or more available items at a level corresponding to the level of interest for the available item, configuring the user interface to display a stack of minimized icons for available items having overlapping levels of interest, and/or configuring the user interface to zoom to enlarge the stacked, minimized icons, including increasing a vertical scale of a display without increasing a horizontal scale of the display.

The method may further include configuring the user interface to display detailed information regarding a first available item, upon receiving a selection of a first available item, and to download the first available item upon receiving instructions to download the first available item via the detailed display of information.

In addition, the calculations can separate the available items according to their release date, so that a user can view a display showing the most popular available items released on a plurality of dates. As illustrated in FIGS. 1 and 2, a user may start at the present date and scroll to see the rating for available items released on previous days.

In addition, the user interface may display an icon for each of the available items at a level corresponding to the calculated level of interest for the available item. The user interface may comprise a stacking mechanism that displays a stack of minimized icons for available items having overlapping levels of interest. The user interface may further include a zooming mechanism that enables a user to enlarge the stacked, minimized icons, wherein the zooming mechanism increases the vertical scale of a display without increasing the horizontal scale of the display.

Further, aspects may include calculating a level of interest for one or more available items, or one or more types of available items, and generating a display based on the calculation. Then, options and filters may be applied or offered to a user for selection in order to narrow the display to particular types of available items.

Further, aspects may include calculating a personalized level of interest for one or more available items, without performing media searches. Thus, the level of interest may be based, for example, on information gathered regarding the one or more available items from contacts identified in the user's list of contacts. For example, the level of interest may be determined based on purchases made by the user's friends of particular content, without performing additional media searches.

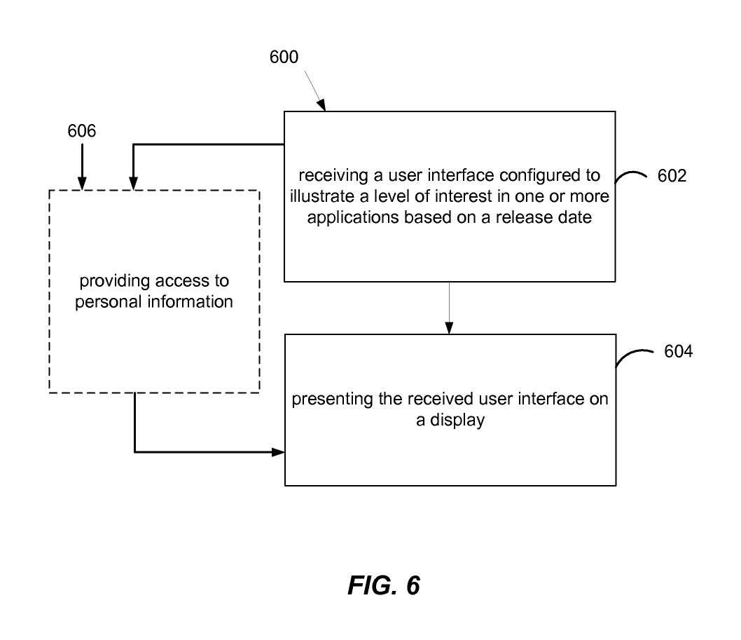

FIG. 6 illustrates a flow chart showing example aspects of a method 600 for obtaining a level of interest in one or more applications. For example, in an aspect, method 600 may be operable by a mobile device. The method includes receiving a user interface configured to illustrate a level of interest in one or more applications based on a release date. The level of interest for each of the one or more applications is calculated based on a media search for discussion of each of the one or more applications 602. Media may include social media. Searching the media for discussion of each of the one or more applications includes determining a number of times that each of the one or more applications is named in the media.

The method further includes presenting the received user interface on a display 604.

The method further may optionally include providing access to personal information. In such aspect, the user interface is further configured to illustrate a personalized level of interest in one or more available items based on the received personal information 606.

Providing access to user information may include providing login credentials for a social network. For example, the UE may provide log in credentials to the user's account in social media etc. The UE may provide access to contact list information or location information. For example, the UE may provide access to a contact list stored on the UE, or using GPS, the UE may periodically determine and report its location. Then, the calculated level of interest in the one or more available items can be personalized based on such user information. For example, the calculation may include data mining of the user's social media accounts to determine the amount of discussion regarding each of the one or more available items specific to the user's friends and contacts. The contact list information may be used to weight the number of downloads/comments made by persons included in the user's contact list.

The level of interest may be further calculated based on a determination of at least one of a number of downloads or a number of purchases for each of the plurality of applications.

The user interface may be further configured to illustrate the level of interest in content, and the method may include providing access to personal information. In such aspect, he user interface is further configured to illustrate a personalized level of interest in one or more available items based on the received personal information.

Providing access to personal information may include providing access to at least one of login credentials for a social network, contact list information, or location information.

If providing access to personal information includes providing access to login credentials for a social network of a user of a mobile device, calculating the level of interest may further include searching the social network of the user to determine the level of interest in the one or more available items based on the social network of the user. If providing access to personal information includes providing access to contact list information identifying a plurality of contacts, the level of interest may be further calculated based on a search for purchases of any of the one or more available items by any of the plurality of contacts, and/or a search for comments regarding any of the one or more available items by any of the plurality of contacts.

The level of interest may be calculated based on determining a number of overall downloads, A, for each of the one or more available items, determining a number of downloads made by contacts of a user, B, and calculating a level of interest by calculating A−B+x(B), wherein x is a numerical multiplier to weight the level of interest based on the contacts of the user.

Aspects may further include displaying an icon for each of the one or more available items at a level corresponding to the level of interest for the available item, displaying a stack of minimized icons for the available items having overlapping levels of interest, and/or zooming to enlarge the stacked, minimized icons, including increasing a vertical scale of the display without increasing a horizontal scale of the display.

Aspects may further include receiving a selection of a first available item, displaying detailed information regarding the first available item, receiving instructions to download the first available item via the detailed display of information, and downloading the first available item.

Displaying the level of interest in the one or more available items may include displaying a level of interest in the one or more available items according to a release date of each of the one or more available items and scrolling through the display according to a plurality of release dates. A user may scroll the display to show different levels of interest in the one or more available items.

Aspects may further include receiving a selection of a first available item. Upon such a selection, the detailed information for the available item is displayed, such as in FIG. 4. A user can input instructions to download the available item via the user interface showing the detailed display of information. The UE then downloads the available item.

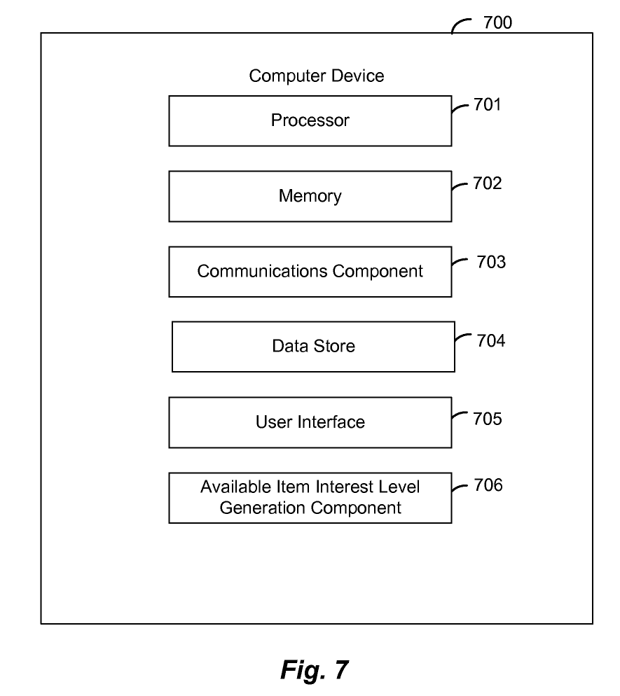

Referring to FIG. 7, in one aspect, a network device for generating the above-described available item interest and ranking information may be represented by computer device 700. Computer device 700 includes a processor 701 for carrying out processing functions associated with one or more of components and functions described herein. Processor 701 can include a single or multiple set of processors or multi-core processors. Moreover, processor 701 can be implemented as an integrated processing system and/or a distributed processing system.

Computer device 700 further includes a memory 702, such as for storing local versions of applications being executed by processor 701. Memory 702 can include ay type of memory usable by a computer, such as random access memory (RAM), read only memory (ROM), tapes, magnetic discs, optical discs, volatile memory, non-volatile memory, and any combination thereof

Further, computer device 700 includes a communications component 703 that provides for establishing and maintaining communications with one or more parties utilizing hardware, software, and services as described herein. Communications component 703 may carry communications between components on computer device 700, as well as between computer device 700 and external devices, such as devices located across a communications network and/or devices serially or locally connected to computer device 700. For example, communications component 700 may include one or more buses, and may further include transmit chain components and receive chain components associated with a transmitter and receiver, respectively, operable for interfacing with external devices.

Additionally, computer device 700 may further include a data store 704, which can be any suitable combination of hardware and/or software, that provides for mass storage of information, databases, and programs employed in connection with aspects described herein. For example, data store 704 may be a data repository for applications not currently being executed by processor 701.

Computer device 700 may additionally include a user interface component 705 operable to receive inputs from a user of computer device 700, and further operable to generate outputs for presentation to the user. User interface component 705 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 705 may include one or more output devices, including but not limited to a display, a speaker, a haptic feedback mechanism, a printer, any other mechanism capable of presenting an output to a user, or any combination thereof

Computer device 700 may additionally include an available item interest level generation component 706 executed by processor 701, component 706 being configured to determine a release date for one or more available items, e.g. for one or more applications, and calculate a level of interest for the one or more applications. In one example, calculating the level of interest includes searching media for discussion of each of the one or more applications. The component 706 is further operable to generate a user interface configured to illustrate the level of interest in the one or more applications. Then, the computer device may provide such generated information via the communications component 703. Access to personal information at a mobile device may be accomplished via communications component 703 in order to enable a personalized calculation of a level of interest in one or more available items.

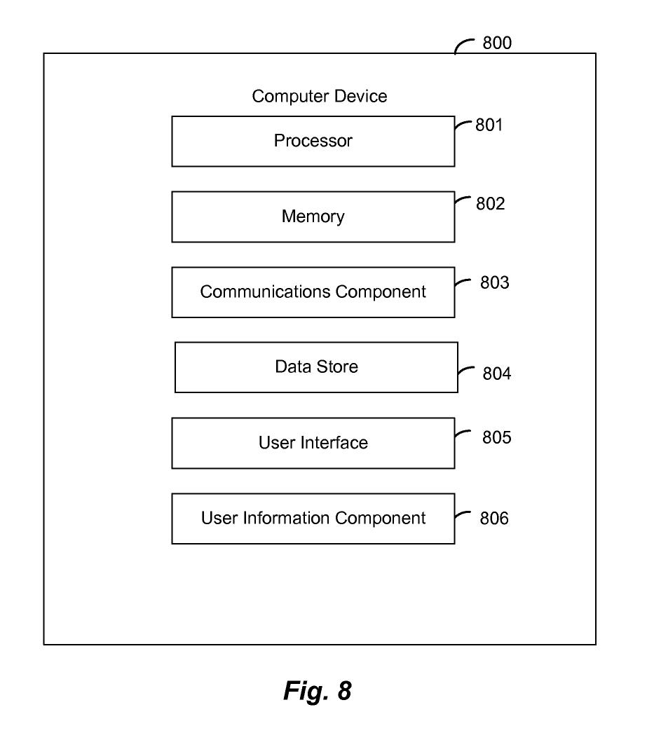

Referring to FIG. 8, in one aspect, UE 102 (FIG. 1) may be represented by computer device 800. Computer device 800 includes a processor 801 for carrying out processing functions associated with one or more of components and functions described herein. Processor 801 can include a single or multiple set of processors or multi-core processors. Moreover, processor 801 can be implemented as an integrated processing system and/or a distributed processing system.

Computer device 800 further includes a memory 802, such as for storing local versions of applications being executed by processor 801. Memory 802 can include ay type of memory usable by a computer, such as random access memory (RAM), read only memory (ROM), tapes, magnetic discs, optical discs, volatile memory, non-volatile memory, and any combination thereof

Further, computer device 800 includes a communications component 803 that provides for establishing and maintaining communications with one or more parties utilizing hardware, software, and services as described herein. Communications component 803 may carry communications between components on computer device 800, as well as between computer device 800 and external devices, such as devices located across a communications network and/or devices serially or locally connected to computer device 800. For example, communications component 800 may include one or more buses, and may further include transmit chain components and receive chain components associated with a transmitter and receiver, respectively, operable for interfacing with external devices.

Additionally, computer device 800 may further include a data store 804, which can be any suitable combination of hardware and/or software, that provides for mass storage of information, databases, and programs employed in connection with aspects described herein. For example, data store 804 may be a data repository for applications not currently being executed by processor 801.

Computer device 800 may additionally include a user interface component 805 operable to receive inputs from a user of computer device 800, and further operable to generate outputs for presentation to the user. User interface component 805 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 805 may include one or more output devices, including but not limited to a display, a speaker, a haptic feedback mechanism, a printer, any other mechanism capable of presenting an output to a user, or any combination thereof

Computer device 800 may additionally include a user information component 806 configured to provide access to user information to a wireless via the computer device, so that the computer device may receive access to a user interface configured to display a personalized level of interest in the one or more available items, e.g. applications, based at least in part on discussion of each of the one or more available items within media. User information component may be executed via processor 801.

Access to personal information may be provided to a network via communications component 803 in order to enable computer device 800 to receive a user interface having a personalized calculation of a level of interest in one or more available items.

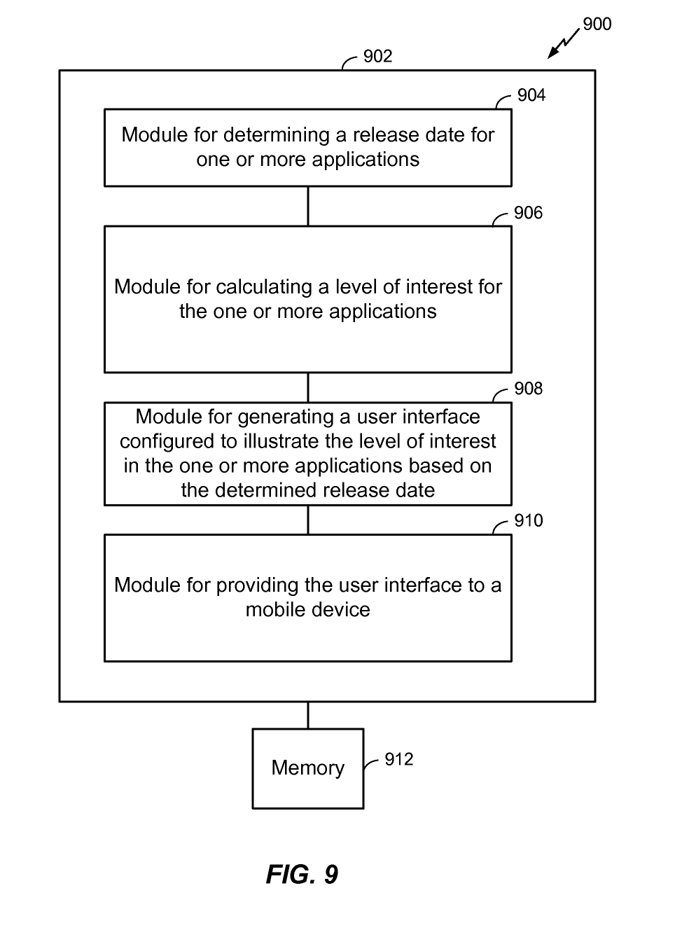

With reference to FIG. 9, illustrated is a system 900 that generates application interest and ranking information, according to one aspect. For example, system 900 can reside at least partially within a computer device, such as a network device, etc. It is to be appreciated that system 900 is represented as including functional blocks, which can be functional blocks that represent functions implemented by a processor, software, or combination thereof (e.g., firmware). System 900 includes a logical grouping 902 of electrical components that can act in conjunction. For instance, logical grouping 902 can include a module for determining a release date for one or more applications 904. For example, logical grouping 904 may correspond to components within computer device 700 in FIG. 7.

Further, logical grouping 902 can comprise a module for calculating a level of interest for the one or more applications. Calculating the level of interest includes searching media for discussion of each of the one or more applications 906.

Furthermore, logical grouping 902 can comprise a module for generating a user interface configured to illustrate the level of interest in the one or more applications based on the determined release date 908.

Logical grouping 902 may further comprise a module for providing the user interface to a mobile device 910.

System 900 may further include memory 912 that retains instructions for executing functions associated with electrical components 904, 906, 908, and 910. While shown as being external to memory 912, it is to be understood that one or more of electrical components 904, 906, 908, and 910 can exist within memory 912. In an aspect, for example, memory 912 may be the same as or similar to memory 702 or data store 704 in FIG. 7.

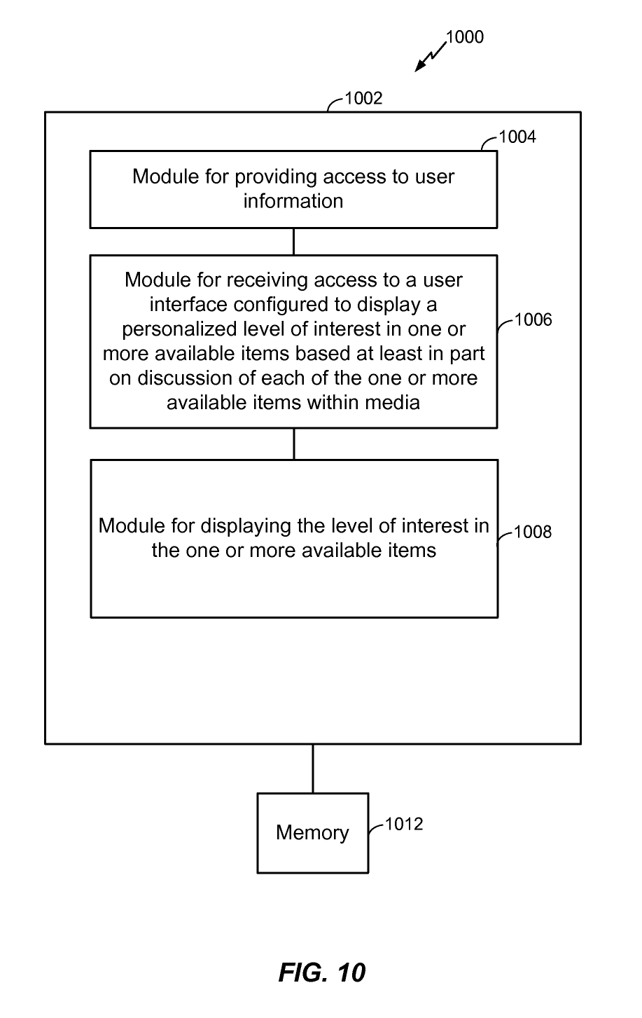

With reference to FIG. 10, illustrated is a system 1000 that obtains and displays a level of interest, which may be personalized, in one or more available items. For example, system 1000 can reside at least partially within a computer device, such as a mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For example, logical grouping 904 may correspond to components within computer device 800 in FIG. 8.

For instance, logical grouping 1002 can include a module for providing access to user information 1004.

Further, logical grouping 1002 can comprise a module for receiving access to a user interface configured to display a personalized level of interest in the one or more available items based at least in part on discussion of each of the one or more content items within media 1006.

Furthermore, logical grouping 1002 can comprise a module for displaying the level of interest in the one or more available items 1008.

System 1000 may further include memory 1012 that retains instructions for executing functions associated with electrical components 1004, 1006, and 1008. While shown as being external to memory 1012, it is to be understood that one or more of electrical components 1004, 1006, and 1008 can exist within memory 1012. In an aspect, for example, memory 1012 may be the same as or similar to memory 802 or data store 804 in FIG. 8.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An example storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for representing a level of interest in an available item, the method comprising:
determining a release date for one or more applications;
calculating a level of interest for each of the one or more applications, wherein calculating the level of interest includes searching media for discussion of each of the one or more applications;
generating a user interface configured to illustrate the level of interest in each of the one or more applications based on the determined release date; and
providing the user interface to a mobile device.

2. The method according to claim 1, wherein media includes social media, and wherein searching the media for discussion of each of the one or more applications includes determining a number of times that each of the one or more applications is named in the media.

3. The method according to claim 1, wherein calculating the level of interest further includes determining at least one of a number of downloads or a number of purchases for each of the one or more applications.

4. The method according to claim 1, further comprising:
receiving personal information from the mobile device; and
calculating a personalized level of interest for one or more available items based on the received personal information.

5. The method according to claim 4, wherein receiving personal information from the mobile device includes receiving at least one of login credentials for a social network, contact list information, or location information.

6. The method according to claim 4, wherein receiving personal information from the mobile device includes receiving login credentials for a social network of a user of the mobile device, the method further comprising:
searching the social network of the user to determine the level of interest in the one or more available items based on the social network of the user.

7. The method according to claim 4, wherein receiving personal information from the mobile device includes receiving contact list information identifying one or more contacts, the method further comprising:
searching for purchases of any of the one or more available items by any of the one or more contacts; and
searching for comments regarding any of the one or more available items by any of the one or more contacts.

8. The method according to claim 4, wherein calculating the level of interest for the one or more available items includes:
determining a number of overall downloads, A, for each of the one or more available items;
determining a number of downloads made by one or more contacts of a user, B; and
calculating the level of interest for each of the one or more available items by calculating A−B+x(B), wherein x is a numerical multiplier to weight the level of interest based on the one or more contacts of the user.

9. The method according to claim 4, further comprising configuring the user interface to display an icon for each of the one or more available items at a level corresponding to the level of interest for the content.

10. The method according to claim 9, further comprising configuring the user interface to display a stack of minimized icons for available items having overlapping levels of interest.

11. The method according to claim 10, further comprising configuring the user interface to zoom to enlarge the stack of minimized icons, including increasing a vertical scale of a display without increasing a horizontal scale of the display.

12. The method according to claim 9, further comprising configuring the user interface to:
display detailed information regarding a first available item, upon receiving a selection of a first available item; and
download the first available item, upon receiving an instruction to download the first available item via the display of detailed information.

13. At least one processor configured to represent a level of interest in an available item, the processor comprising:
a first module for determining a release date for one or more applications;
a second module for calculating a level of interest for each of the one or more applications, wherein calculating the level of interest includes searching media for discussion of each of the one or more applications;
a third module for generating a user interface configured to illustrate the level of interest in each of the one or more applications based on the determined release date; and
a fourth module for providing the user interface to a mobile device.

14. A computer program product to represent a level of interest in an available item, comprising:
a non-transitory computer-readable medium comprising:
at least one instruction for causing a computer to determine a release date for one or more applications;
at least one instruction for causing the computer to calculate a level of interest for each of the one or more applications, wherein calculating the level of interest includes searching media for discussion of each of the one or more applications;
at least one instruction for causing the computer to generate a user interface configured to illustrate the level of interest in each of the one or more applications based on the determined release date; and
at least one instruction for causing the computer to provide the user interface to a mobile device.

15. An apparatus to represent a level of interest in an available item, comprising:
means for determining a release date for one or more applications;
means for calculating a level of interest for each of one or more applications, wherein calculating the level of interest includes searching media for discussion of each of the one or more applications;
means for generating a user interface configured to illustrate the level of interest in each of the one or more applications based on the determined release date; and
means for providing the user interface to a mobile device.

16. An apparatus to represent a level of interest in an available item, comprising:
an application interest level generation component configured to determine a release date for one or more applications, calculate a level of interest for each of the one or more applications, wherein calculating the level of interest includes searching media for discussion of each of the one or more applications, and generate a user interface configured to illustrate the level of interest in each of the one or more applications based on the determined release date; and
a transmitter configured to provide the user interface to a mobile device.

17. The apparatus according to claim 16, wherein media includes social media, and wherein searching the media for discussion of each of the one or more applications includes determining a number of times that each of the one or more applications is named in the media.

18. The apparatus according to claim 16, wherein calculating the level of interest further includes determining at least one of a number of downloads or a number of purchases for each of the one or more applications.

19. The apparatus according to claim 16, wherein the application interest level generation component is further configured to receive personal information from the mobile device and to calculate a personalized level of interest for one or more available items based on the received personal information.

20. The apparatus according to claim 19, wherein the personal information includes at least one of login credentials for a social network, contact list information, or location information.

21. The apparatus according to claim 19, wherein the personal information from the mobile device includes login credentials for a social network of a user of the mobile device, and wherein the application interest level generation component is further configured to search the social network of the user to determine the level of interest in the one or more available items based on the social network of the user.

22. The apparatus according to claim 19, wherein the personal information includes contact list information identifying one or more contacts, and wherein the application interest level generation component is further configured to search for purchases of any of the one or more available items by any of the one of more contacts and search for comments regarding any of the one or more available items by any of the one or more contacts.

23. The apparatus according to claim 19, wherein calculating the level of interest for the one or more available items includes:
determining a number of overall downloads, A, for each of the one or more available items;
determining a number of downloads made by the one or more contacts of a user, B; and
calculating the level of interest by calculating A−B+x(B), wherein x is a numerical multiplier to weight the level of interest based on the one or more contacts of the user.

24. The apparatus according to claim 19, wherein the user interface is configured to display an icon for each of the one or more available items at a level corresponding to the level of interest for the content.

25. The apparatus according to claim 24, wherein the user interface is further configured to display a stack of minimized icons for available items having overlapping levels of interest.

26. The apparatus according to claim 25, wherein the user interface is further configured to zoom to enlarge the stack of minimized icons, including increasing a vertical scale of a display without increasing a horizontal scale of the display.

27. The apparatus according to claim 24, wherein the user interface is further configured to display detailed information regarding a first available item, upon receiving a selection of a first available item and to download the first available item, upon receiving an instruction to download the first available item via the display of detailed information.

28. A method for obtaining a level of interest in an available item, the method comprising:
receiving a user interface configured to represent the level of interest in one or more applications based on a release date, wherein the level of interest for each of the one or more applications is calculated based on a media search for discussion of each of the one or more applications; and
presenting the received user interface on a display.

29. The method according to claim 28, wherein the media search identifies media that includes social media, and wherein searching the media for discussion of each of the one or more applications includes determining a number of times that each of the one or more applications is named in the media.

30. The method according to claim 28, wherein the level of interest is further calculated based on a determination of at least one of a number of downloads or a number of purchases for each of the one or more applications.

31. The method according to claim 28, wherein the user interface is further configured to illustrate the level of interest in content, the method further comprising:
providing access to personal information, wherein the user interface is further configured to illustrate a personalized level of interest in one or more available items based on the received personal information.

32. The method according to claim 31, wherein providing access to personal information includes providing access to at least one of login credentials for a social network, contact list information, or location information.

33. The method according to claim 31, wherein providing access to personal information includes providing access to login credentials for a social network of a user of a mobile device, wherein calculating the level of interest includes searching the social network of the user to determine the level of interest in the one or more available items based on the social network of the user.

34. The method according to claim 31, wherein providing access to personal information includes providing access to contact list information identifying one or more contacts, wherein the level of interest is further calculated based on a search for purchases of any of the one or more available items by any of the one or more contacts; and a search for comments regarding any of the one or more available items by any of the one or more contacts.

35. The method according to claim 31, wherein the level of interest is calculated based on:
determining a number of overall downloads, A, for each of the one or more available items;
determining a number of downloads made by one or more contacts of a user, B; and
calculating the level of interest by calculating A−B+x(B), wherein x is a numerical multiplier to weight the level of interest based on the one or more contacts of the user.

36. The method according to claim 31, further comprising:
displaying an icon for each of the one or more available items at a level corresponding to the level of interest for the content.

37. The method according to claim 36, further comprising:
displaying a stack of minimized icons for available items having overlapping levels of interest.

38. The method according to claim 37, further comprising zooming to enlarge the stack of minimized icons, including increasing a vertical scale of the display without increasing a horizontal scale of the display.

39. The method according to claim 31, further comprising:
receiving a selection of a first available item;
displaying detailed information regarding the first available item;
receiving an instruction to download the first available item via the detailed display of information; and
downloading the first available item.

40. At least one processor configured to obtain a level of interest in at least one available item, the processor comprising:
a first module for receiving a user interface configured to represent the level of interest in one or more applications based on a release date, wherein the level of interest for each of the one or more applications is calculated based on a media search for discussion of each of the one or more applications; and
a second module for presenting the received user interface on a display.

41. A computer program product to obtain a level of interest in at least one available item, comprising:
a non-transitory computer-readable medium comprising:
at least one instruction for causing a computer to receive a user interface configured to represent the level of interest in one or more applications based on a release date, wherein the level of interest for each of the one or more application is calculated based on a media search for discussion of each of the one or more applications; and
at least one instruction for causing the computer to present the received user interface on a display.

42. An apparatus to obtain a level of interest in at least one available item, comprising:
means for receiving a user interface configured to represent the level of interest in one or more applications based on a release date, wherein the level of interest for each of the one or more applications is calculated based on a media search for discussion of each of the one or more applications; and
means for presenting the received user interface on a display.

43. An apparatus to obtain a level of interest in at least one available item, comprising:
a communications component configured to receive a user interface configured to illustrate the level of interest in one or more applications based on a release date, wherein the level of interest for each of the one or more applications is calculated based on a media search for discussion of each of the one or more applications; and
a display configured to present the received user interface.

44. The apparatus according to claim 43, wherein media includes social media, and wherein the media search includes searching the media for discussion of each of the one or more applications including determining a number of times that each of the one or more applications is named in the media.

45. The apparatus according to claim 43, wherein the level of interest is further calculated based on a determination of at least one of a number of downloads or a number of purchases for each of the one or more applications.

46. The apparatus according to claim 43, wherein the user interface is further configured to illustrate the level of interest in content, the apparatus further comprising:
a user information component configured to provide access to personal information, wherein the user interface is further configured to illustrate a personalized level of interest in one or more available items based on the received personal information.

47. The apparatus according to claim 46, wherein the personal information includes at least one of login credentials for a social network, contact list information, or location information.

48. The apparatus according to claim 46, wherein the personal information includes login credentials for a social network of a user of a mobile device, and wherein the level of interest is further based on a search of the social network of the user to determine the level of interest in the one or more available items based on the social network of the user.

49. The apparatus according to claim 46, wherein the personal information includes contact list information identifying one or more contacts, wherein the level of interest is further based on a search for purchases of any of the one or more available items by any of the one or more contacts and a search for comments regarding any of the one or more available items by any of the one or more contacts.

50. The apparatus according to claim 46, wherein the level of interest is calculated based on:
determining a number of overall downloads, A, for each of the one or more available items;
determining a number of downloads made by one or more contacts of a user, B; and
calculating the level of interest by calculating A−B+x(B), wherein x is a numerical multiplier to weight the level of interest based on the one or more contacts of the user.

51. The apparatus according to claim 46, wherein the user interface is configured to display an icon for each of the one or more available items at a level corresponding to the level of interest for the content.

52. The apparatus according to claim 51, wherein the user interface is further configured to display a stack of minimized icons for available items having overlapping levels of interest.

53. The apparatus according to claim 52, wherein the user interface is further configured to zoom to enlarge the stack of minimized icons, including increasing a vertical scale of the display without increasing a horizontal scale of the display.

54. The apparatus according to claim 46, wherein the user interface is further configured to:
receive a selection of a first available item;
display detailed information regarding the first available item;
receive an instruction to download the first available item via the detailed display of information; and
download the first available item.
